(19) United States
(12) Patent Application Publication
(10) Pub. No.: US 2018/0094758 A1
(43) Pub. Date: Apr. 5, 2018

(54) FUELING DEVICE

(71) Applicant: TOYODA GOSEI CO., LTD., Kiyosu-shi (JP)

(72) Inventor: Hiroyuki HAGANO, Kiyosu-shi (JP)

(21) Appl. No.: 15/709,641

(22) Filed: Sep. 20, 2017

(30) Foreign Application Priority Data
Sep. 30, 2016 (JP) 2016-192637

(51) Int. Cl. F16L 37/14; B60K 15/04

(52) U.S. Cl. CPC F16L 37/144; B67D 7/04; B60K 15/04

(57) ABSTRACT

A flow path-forming member mounted to a pipe opening end of a filler pipe forms an insertion flow path portion in which a fueling nozzle is inserted, such that the insertion flow path portion communicates with a fuel flow path. An opening end engagement portion is arranged to cover a flow path inner circumferential wall a flow path outer circumferential wall and a peripheral wall of the fuel flow path at the pipe opening end around the fuel flow path and is engaged with the filler pipe at the pipe opening end. The flow path-forming member mounted to and engaged with the filler pipe is fastened to the filler pipe by means of a fastening structure, in the state that a pipe outer circumferential wall of the filler pipe is covered by an outer circumference covering portion that is provided from the opening end engagement portion to a downstream side of the fuel flow path. This configuration enhances the effectiveness of preventing the flow path-forming member that forms the insertion flow path portion for the fueling nozzle from being unintentionally detached.

### CROSS-REFERENCE TO RELATED APPLICATION

The present application claims priority from Japanese patent application 2016-192637 filed on Sep. 30, 2016, the entirety of the content of which is hereby incorporated by reference into this application.

### BACKGROUND

### Field

The disclosure relates to a fueling device.

### Related Art

A fueling device includes a flow path-forming member configured to form a nozzle insertion flow path in which a fueling nozzle is inserted. This flow path-forming member is provided with a filler portion open-close valve such as a flap valve. Due to need for replacement of a component accompanied with damage of the valve, the flow path-forming member has been proposed to be detachable as described in JP 2015-67139A. This fueling device includes a retainer member mounted to the flow path-forming member, in order to engage the flow path-forming member with a mounting object, for example, a filler pipe or a filler neck.

On every occasion of fueling using the fueling device, the person who supplies fuel manually inserts the fueling nozzle into the flow path-forming member. This may result in in changing the insertion attitude and the insertion speed of the fueling nozzle on every occasion of fueling and may cause an external force by insertion of the nozzle to be applied to the retainer member via the flow path-forming member. The retainer member is engaged with the flow path-forming member in the mounted state. Application of the external force by insertion of the nozzle is, however, practically unpredictable, and the external force may be applied to the retainer member in a direction of loosening the engagement with the flow path-forming member. There is accordingly a need to enhance the effectiveness of preventing the flow path-forming member from being unintentionally detached.

In order to solve at least part of the problems described above, the disclosure may be implemented by aspects described below.

### SUMMARY

(1) According to one aspect of the present disclosure, there is provided a fueling device. This fueling device is configured to introduce a fuel supplied from a fueling nozzle, to a fuel tank and comprises a filler pipe configured to form a fuel flow path that is extended to the fuel tank; and a flow path-forming member configured to form an insertion flow path portion in which the fueling nozzle is inserted, such that the insertion flow path portion communicates with the fuel flow path at a pipe opening end of the filler pipe. This flow path-forming member comprises an opening end engagement portion that is arranged to cover a flow path inner circumferential wall, a flow path outer circumferential wall and a peripheral wall of the fuel flow path at the pipe opening end around the fuel flow path and that is engaged with the filler pipe at the pipe opening end; an outer circumference covering portion that is provided from the opening end engagement portion to a downstream side of the fuel flow path and that is arranged to cover a pipe outer circumferential wall of the filler pipe; and a fastening structure that is provided on the outer circumference covering portion and that is configured to fasten the outer circumference covering portion to the filler pipe.

In the fueling device of this aspect, an external force by insertion of the fueling nozzle is applied to the opening end engagement portion that is engaged with the pipe opening end of the filler pipe. This opening end engagement portion is arranged to cover the flow path inner circumferential wall, the flow path outer circumferential wall and the peripheral wall of the fuel flow path at the pipe opening end around the fuel flow path. This configuration receives the external force applied by insertion of the fueling nozzle, so as to reduce the external force applied to the fuel flow path on the downstream side of the opening end engagement portion and reduce the possibility of excessive concentration of the external force in the fuel flow path on the downstream side of opening end engagement portion. Accordingly only a small external force is applied to the outer circumference covering portion provided from the opening end engagement portion to the downstream side of the fuel flow path to cover the pipe outer circumferential wall of the filler pipe and to the fastening structure provided to fasten this outer circumference covering portion to the filler pipe. As a result, the fueling device of this aspect suppresses fastening of the fastening structure from being loosened by application of an external force and enhances the effectiveness of preventing the flow path-forming member from being unintentionally detached.

(2) In the fueling device of the above aspect, the fastening structure may include a fastening piece that is configured to maintain a coupling state of the outer circumference covering portion and the filler pipe, and a resilient member that is configured to apply a resilient force generated by deformation to the fastening piece. The resilient member may be detachably mounted such that the resilient force of the resilient member is applied to hold the fastening piece at such a position that maintains the coupling state of the outer circumference covering portion and the filler port. The resilient force generated by the resilient member is applied to the fastening piece, so as to maintains the state that the outer circumferential covering portion is fastened to the filler pipe. The flow path-forming member may be detachable from the filler pipe when the resilient member is detached to prevent the resilient force of the resilient member from being applied to the fastening piece. Additionally, the fastening structure is located on the downstream side of the opening end engagement portion in the fuel flow path. This configuration reduces the external force applied to the resilient member mounted to the fastening structure and thereby reduces the possibility that the resilient member mounted to the fastening structure is unintentionally detached from the fastening structure by an external force.

The present disclosure may be implemented by various aspects, for example, an open-close device for an insertion port in which the fueling nozzle is inserted.

### BRIEF DESCRIPTION OF DRAWINGS

FIG. 1 is a diagram illustrating the outline of a fueling device configured to introduce a fuel supplied from a fueling nozzle, to a fuel tank of a vehicle;

FIG. 2 is a perspective view illustrating the state of a filler neck fastened to a filler pipe by a fastening structure;

FIG. 3 is a perspective view illustrating the state of the filler neck prior to fastening by the fastening structure;

FIG. 4 is a sectional view illustrating the filler neck taken along a line 4-4 in FIG. 2;

FIG. 5 is a diagram illustrating the configuration of a fastening structure and the state prior to mounting the fastening structure to the filler pipe;

FIG. 6 is a sectional view illustrating fastening pieces taken along a line 6-6 in FIG. 5;

FIG. 7 is a sectional view illustrating the fastening pieces taken along a line 7-7 in FIG. 5;

FIG. 8 is a sectional view illustrating retreat of the fastening pieces taken along a line 8-8 in FIG. 5;

FIG. 9 is a diagram illustrating the state of mounting to the filler pipe by the fastening pieces, along with a pipe engagement portion; and

FIG. 10 is a diagram illustrating the fueling nozzle at the time of completion of insertion, in relation to the behavior of a lower end open-close mechanism.

### DESCRIPTION OF EMBODIMENTS

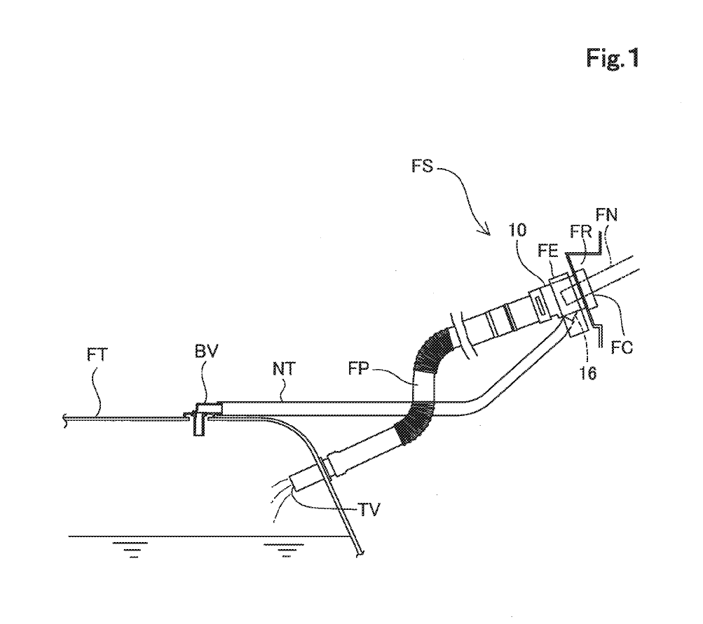

FIG. 1 is a diagram illustrating the outline of a fueling device FS configured to introduce a fuel supplied from a fueling nozzle FN, to a fuel tank FT of a vehicle. The fueling device FS of this embodiment includes a filler neck 10, a fuel vapor port 16, a filler pipe FP, a check valve TV, a fuel vapor tube NT, a gas release valve BV, and a mounting member FE. The filler neck 10 as a flow path-forming member is fixed to a fueling chamber FR of the vehicle by means of the mounting member FE and receives insertion of the fueling nozzle FN into a filler port FC that is an insertion port. This filler neck 10 is connected with the fuel tank FT by the filler pipe FP and the fuel vapor tube NT. The filler pipe FP may be, for example, a resin tube having bellows-like structures at two different positions and is configured to be extendable and bendable in a certain range. This filler pipe FP is connected with the fuel tank FT via the check valve TV. The fuel discharged from the fueling nozzle FN that is inserted into the filler port FC flows through a fuel flow path formed by the filler neck 10 as described later and the filler pipe FP and is introduced from the check valve TV into the fuel tank FT. The check valve TV serves to prevent the reverse flow of the fuel from the fuel tank FT to the filler pipe FP.

The fuel vapor tube NT has one end that is connected with the fuel tank FT via the gas release valve BV and the other end that is connected with the fuel vapor port 16 protruded from the filler neck 10. The gas release valve BV serves as a joint to connect the fuel vapor tube NT with the fuel tank FT. The air in the tank that includes the fuel vapor is flowed from the gas release valve BV into the fuel vapor tube NT. The fuel vapor is introduced along with the supplied fuel through the filler pipe FP into the fuel tank FT during fueling from the fueling nozzle FN. The following describes the configuration of the main part of the fueling device FS in detail.

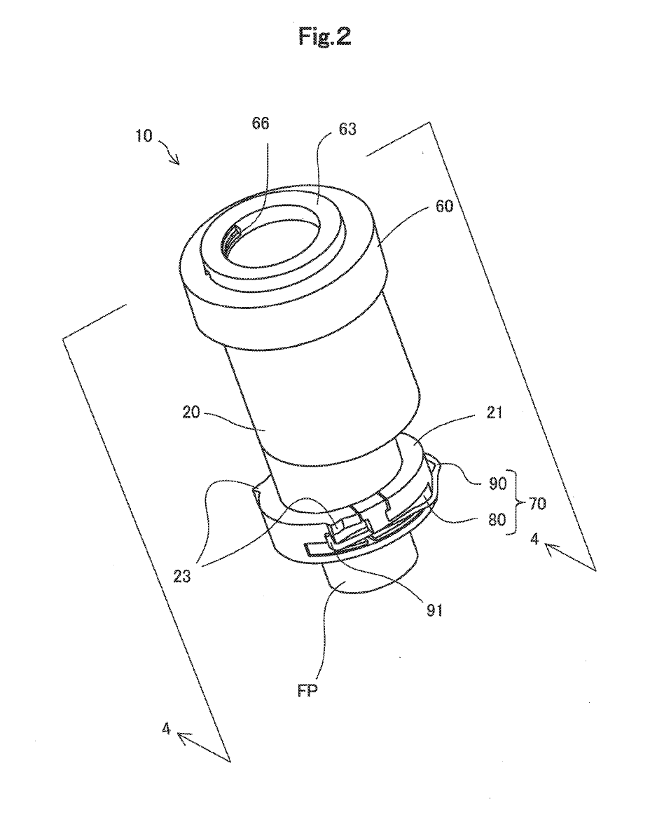

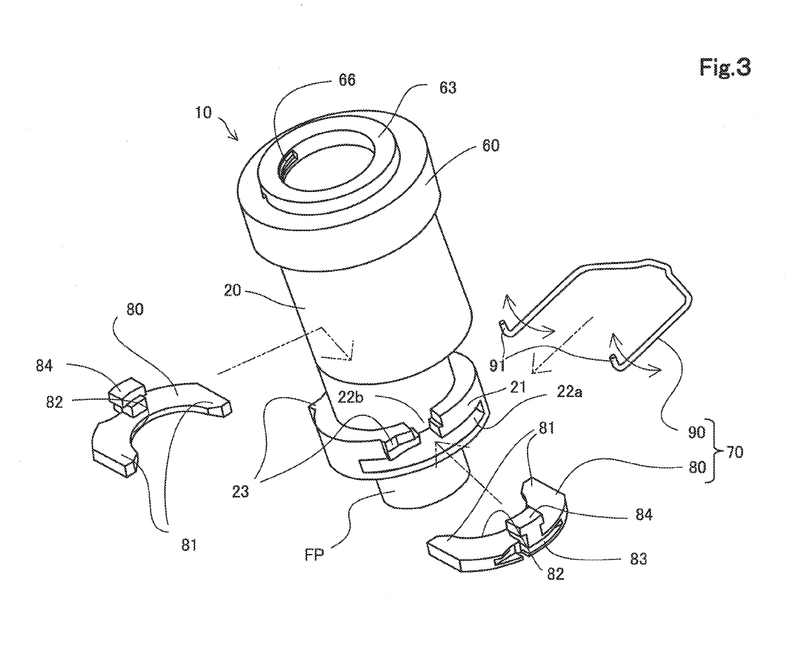

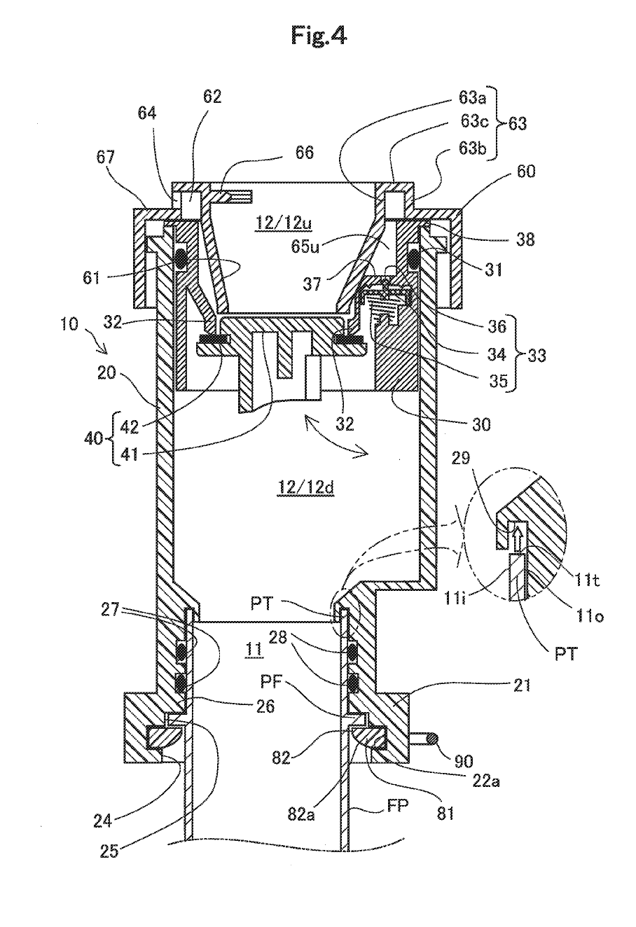

FIG. 2 is a perspective view illustrating the state of the filler neck 10 fastened to the filler pipe FP by a fastening structure 70. FIG. 3 is a perspective view illustrating the state of the filler neck 10 prior to fastening by the fastening structure 70. FIG. 4 is a sectional view illustrating the filler neck 10 taken along a line 4-4 in FIG. 2. For convenience of illustration of engagement in an internal configuration, lines other than those representing the outline are appropriately omitted in FIG. 4. The fuel vapor port 16 shown in FIG. 1 is provided in the filler neck 10 but is not illustrated in FIG. 2 and subsequent drawings for the simplicity of illustration.

The filler neck 10 is a mechanism fastened on its lower end side to the filler pipe FP (shown in FIG. 1) by the fastening structure 70 and configured to feed the fuel discharged from the fueling nozzle FN (shown in FIG. 1), to the fuel tank FT. The filler neck 10 includes a neck main body 20, a flow path-forming auxiliary member 30, a lower end open-close mechanism 40, an insertion flow path portion forming member 60 and the fastening structure 70. The fastening structure 70 includes two fastening pieces 80 placed on and mounted to the filler neck 10 and a resilient member 90 configured to generate a resilient force. The fastening pieces 80 are detachably mounted to left and right sides of the filler neck 10. The resilient member 90 applies a resilient force to the fastening pieces 80 placed on and mounted to the filler neck 10, as a force of maintaining the mounted state. Mounting of the fastening pieces 80 to the filler neck 10 and the configuration of the fastening piece 80 will be described later.

The filler neck 10 includes a pipe engagement portion 21 that is provided continuously from a lower end of the neck main body 20 in a tubular shape and forms a nozzle insertion flow path portion 12 that is extended from the filler port FC (shown in FIG. 1) on the insertion flow path portion forming member 60-side to an end of the pipe engagement portion 21. The nozzle insertion flow path portion 12 is a flow path portion in which the fueling nozzle FN is inserted and is arranged to communicate with a fuel flow path 11 formed by the filler neck 10 at a pipe opening end PT of the filler pipe FP. The nozzle insertion flow path portion 12 is parted. by the flow path-forming auxiliary member 30 and the insertion flow path portion forming member 60 into an upstream-side flow path portion 12u on the filler port FC-side and a downstream-side flow path portion 12d on the filler pipe FP-side. The filler neck 10 configured to form the nozzle insertion flow path portion 12 as described above corresponds to the flow path-forming member of the claims.

The neck main body 20 is provided with the flow path-forming auxiliary member 30 and the insertion flow path portion forming member 60 in an upstream side of the nozzle insertion flow path portion 12. The pipe engagement portion 21 is provided on an end of the nozzle insertion flow path portion 12. As shown in FIG. 3, this pipe engagement portion 21 includes fastening piece insertion holes 22a, fastening piece insertion recesses 22b, and engagement projections 23. The fastening piece insertion hole 22a is formed to pass through the pipe engagement portion 21 from its outer circumferential wall side in a direction from the front side of the sheet surface to the back side of the sheet surface of FIG. 3 and is used for insertion and mounting of the fastening structure 70 as described later. The fastening piece insertion recess 22b is a recess configured to receive a projection 84 of the fastening structure 70 described later. The engagement projection 23 is formed to be raised from an outer circumferential wall of the pipe engagement portion 21 and serves to retain the resilient member 90.

As shown in FIG. 4, the pipe engagement portion 21 additionally includes a pipe insertion hole 24, a flange retention hole 25, a pipe insertion hole portion 26, seal member receiving structures 27, seal members 28, and an opening end insertion recess 29. The seal member receiving structure 27 is formed to be recessed from a wall surface of the pipe insertion hole portion 26, and the seal member 28 is placed in the seal member receiving structure 27. A partial enlarged view of FIG. 4 illustrates the state prior to insertion of the pipe opening end PT into the opening end insertion recess 29 for the purpose of illustration of the reference signs of the members.

The pipe insertion hole 24 and the flange retention hole 25 are arranged vertically across the fastening piece insertion hole 22a and both have diameters that are than the diameter of a flange PF of the filler pipe FP but are smaller than the opening width of the fastening piece insertion hole 22a. The pipe insertion hole portion 26 has a diameter that is smaller than the pipe diameter of the flange PF and forms the opening end insertion recess 29 on the pipe opening end PT-side of the filler pipe FP. The opening end insertion recess 29 is a ring-shaped recess configured to receive the pipe opening end PT of the filler pipe FP and is formed on an inner inclined wall from the neck main body 20 to the pipe engagement portion 21. This opening end insertion recess 29 is arranged to continuously cover a flow path inner circumferential wall 11t a flow path outer circumferential wall 11o and a peripheral wall 11t of the fuel flow path 11 at the pipe opening end PT around the fuel flow path 11 and is engaged with the filler neck 10 at the pipe opening end PT. The opening end insertion recess 29 accordingly corresponds to the opening end engagement portion of the claims The pipe insertion hole portion 26 provided from the opening end insertion recess 29 described above to the downstream side of the fuel flow path 11 is arranged, along with the pipe insertion hole 24 and the flange retention hole 25, to cover a pipe outer circumferential wall of the filler pipe FP. The pipe engagement portion 21 including the pipe insertion hole 24, the flange retention hole 25 and the pipe insertion hole portion 26 accordingly corresponds to the outer circumference covering portion of the claims.

The neck main body 20 including the pipe engagement portion 21 and the fuel vapor port 16 (shown in FIG. 1) is made of a resin material having excellent fuel permeation resistance, for example, polyamide (PA) such as nylon or ethylene vinyl alcohol copolymer (EVOH), in order to suppress permeation of the fuel. The neck main body 20 may be configured to have a two-layer structure including an inner layer and an outer layer, and the outer layer may be made of a resin material having excellent mechanical strength, for example, polyethylene (PE). In this configuration, the outer layer provides the neck main body 20 with the mechanical strength and the impact resistance. When polyethylene is used for this outer layer, the-polyethylene used may be a maleic acid-modified (as a polar functional group) resin material (modified polyethylene). The modified polyethylene is bondable to PA by chemical bonding and is thus bonded to the inner layer.

The flow path-forming auxiliary member 30 is inserted from an upper end opening of the neck main body 20 into the nozzle insertion flow path portion 12 and is thermally welded to the neck main body 20 at its upper end flange portion 38. A ring-shaped seal member 31 having elasticity is placed in an outer wall recess of the flow path-forming auxiliary member 30 to seal the inner wall of the neck main body 20 against the outer wall of the flow path-forming auxiliary member 30 liquid-tightly and gas-tightly. The flow path-forming auxiliary member 30 includes a ring-shaped seal lip wall 32 and a negative pressure cancellation valve mechanism 33 and is additionally configured to support the lower end open-close mechanism 40 that is opened and closed by the fueling nozzle FN. The seal lip wall 32 is arranged to surround the nozzle insertion flow path portion 12 in the vicinity of a boundary between the upstream-side flow path portion 12u and the downstream-side flow path portion 12d and has a lower end that forms a ring-shaped lip portion for sealing the fuel flow path. This flow path-forming auxiliary member 30 may be made of, for example, PA having fuel permeation resistance, like the neck main body 20.

The negative pressure cancellation valve mechanism 33 is placed in a lower portion of a middle wall 37 that is protruded inward in the radial direction from an opening wall of the flow path-forming auxiliary member 30 and includes a valve element 34 that is held by a spring 35. The valve element 34 has a leading end that is placed in an opening 36 formed in the middle wall 37 to open and close this opening 36. The opening 36 is provided at a connecting position of the upstream-side flow path portion 12u and the downstream-side flow path portion 12d to make the upstream-side flow path portion 12u and the downstream-side flow path portion 12d communicate with each other. When the downstream-side flow path portion 12d-side has a negative pressure, the valve element 34 moves in a direction of contracting the spring 35 by its pressure difference to open the opening 36. The negative pressure cancellation valve mechanism 33 accordingly serves to cancel the negative pressure. The valve element 34 of the negative pressure cancellation valve mechanism 33 is also made of, for example, PA.

The lower end open-close mechanism 40 is placed in the flow path-forming auxiliary member 30 and includes a ring-shaped elastic seal member 42 that is mounted to an open-close member 41. The seal member 42 is pressed against and is separated from the lip portion at the leading end of the seal lip wall 32, so that this lower end open-close mechanism 40 closes and opens the upstream-side flow path portion 12u. The open-close member 41 is configured to be rotatable about a bearing portion (not shown) placed in the flow path-forming auxiliary member 30 in an arrow direction of FIG. 4 and to continuously receive a pressing force of a spring (not shown) placed in the flow path-forming auxiliary member 30. During non-fueling without insertion of the fueling nozzle FN, the seal member 42 of the open-close member 41 is pressed against the lip portion at the leading end of the seal lip wall 32, so that the lower end open-close mechanism 40 closes the upstream-side flow path portion 12u. During fueling with insertion of the fueling nozzle FN, on the other hand, the open-close member 41 is pressed by a leading end of the inserted fueling nozzle FN, so that the lower end open-close mechanism 40 rotates the open-close member 41 toward the circumferential wall of the neck main body 20 and opens the upstream-side flow path portion 12u to communicate with the downstream-side flow path portion 12d. The open-close member 41 of the lower end open-close mechanism 40 is made of, for example, POM or PA.

The insertion flow path portion forming member 60 is mounted to the filler neck 10 on a nozzle insertion side where the fueling nozzle FN is inserted, and includes a nozzle guide wall 61, a partition wall 63 and a nozzle guide projection 66. The nozzle guide wall 61 is a ring-shaped member that is located on a flow path inner diameter side of the seal lip wall 32 of the flow path-forming auxiliary member 30 and is configured to form the upstream-side flow path portion 12u that is an insertion flow path portion of the fueling nozzle FN in the nozzle insertion flow path portion 12 on the nozzle insertion side. This nozzle guide wall 61 is arranged to guide the fueling nozzle FN toward the lower end open-close mechanism 40. In a configuration that a flap valve-type another member is mounted to the insertion flow path portion forming member 60, the nozzle guide wall 61 forms at least part of the upstream-side flow path portion 12u.

The partition wall 63 serves in combination with the nozzle guide wall 61 to part the upstream-side flow path portion 12u and form an annular passage 62 that surrounds the upstream-side flow path portion 12u about its axis. The partition wall 63 is comprised of a passage inner wall 63a and a passage outer wall 63b that are opposed to each other across the annular passage 62, as well as a ceiling wall 63c. The passage inner wall 63a is extended from an upper end of the nozzle guide wall 61. As shown in FIG. 4, in the state that the insertion flow path portion forming member 60 is mounted to the filler neck 10, the annular passage 62 surrounded by the passage inner wall 63a, the passage outer wall 63b and the ceiling wall 63c of the partition wall 63 is continuous with a communication chamber 65u on a lower end side of the nozzle guide wall 61. This annular passage 62 communicates with the atmosphere via an air communication hole 64 that is formed in the passage outer wall 63b of the partition wall 63. The flow path-forming auxiliary member 30 located on a downstream side of the insertion flow path portion forming member 60 includes the middle wall 37 at a position opposed to the air communication hole 64. In a remaining region without the middle wall 37, an upper end flange portion 67 forms a bottom wall of the annular passage 62. The insertion flow path portion forming member 60 is further configured such that the opening 36 formed in the middle wall 37 of the flow path-forming auxiliary member 30 that forms a bottom wall of the communication chamber 65u serves as a flow path communication hole to cause the annular passage 62 to communicate with the downstream portion of the nozzle insertion flow path portion 12 on the downstream side of the upstream-side flow path portion 12u. The insertion flow path portion forming member 60 of this configuration is made of, for example, PA having fuel permeation resistance, like the neck main body 20.

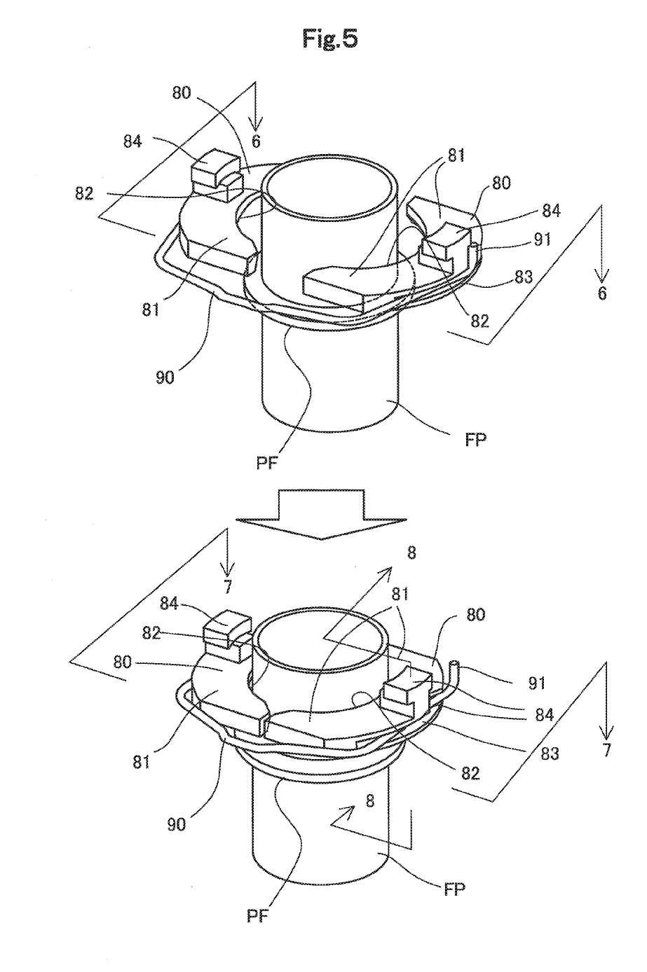

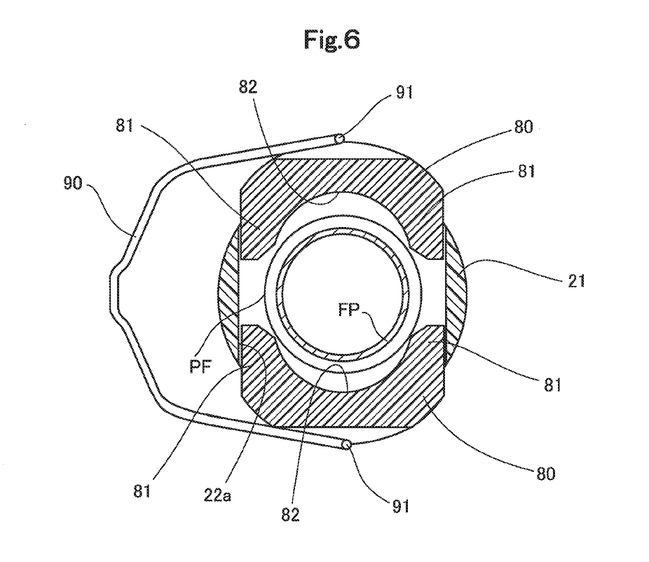

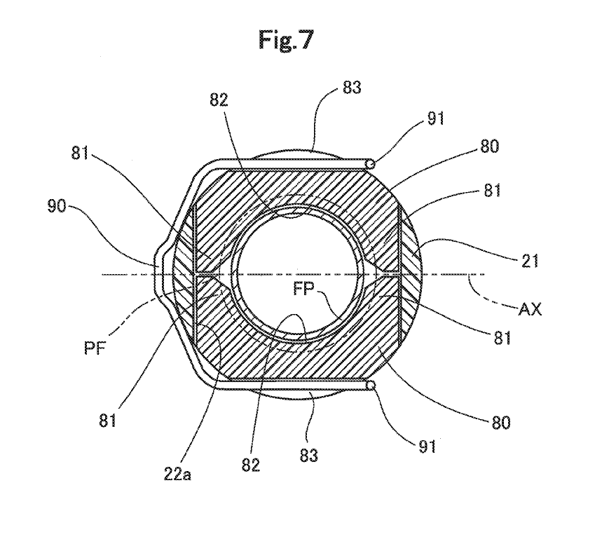

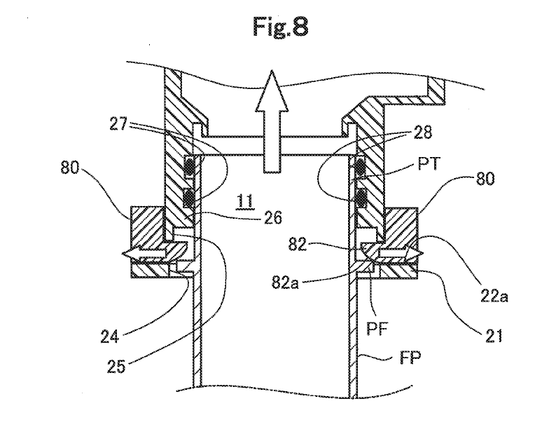

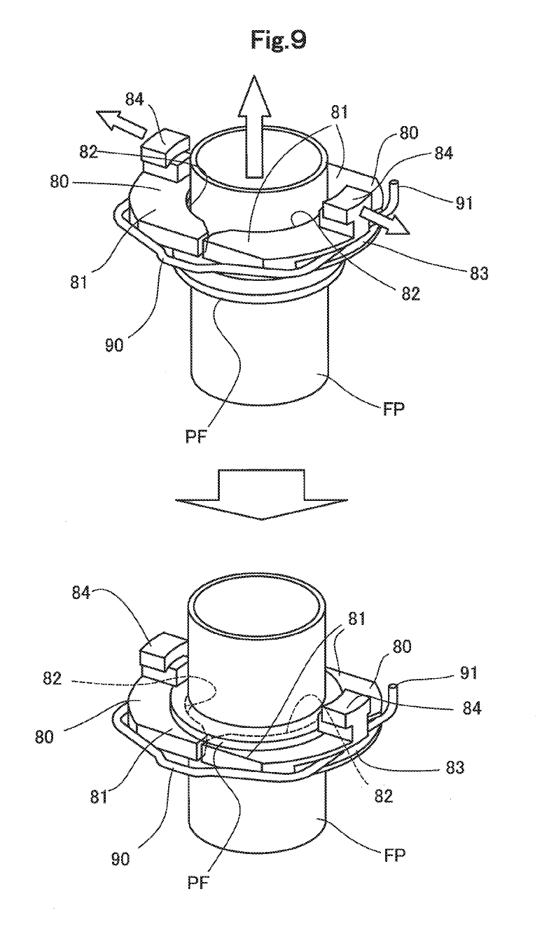

FIG. 5 is a diagram illustrating the configuration of the fastening structure 70 and the state prior to mounting the fastening structure 70 to the filler pipe FP. FIG. 6 is a sectional view illustrating the fastening pieces 80 taken along a line 6-6 in FIG. 5. FIG. 7 is a sectional view illustrating the fastening pieces 80 taken along a line 7-7 in FIG. 5. FIG. 8 is a sectional view illustrating retreat of the fastening pieces 80 taken along a line 8-8 in FIG. 5. FIG. 9 is a diagram illustrating the state of mounting to the filler pipe FP by the fastening pieces 80, along with the pipe engagement portion 21.

As described above with reference to FIG. 3, the fastening structure 70 includes the two fastening pieces 80 and the resilient member 90. The fastening piece 80 is a width across flat-type plate having a thickness insertable into the fastening piece insertion hole 22a formed in the pipe engagement portion 21 and a width insertable into the fastening piece insertion hole 22a. The two fastening pieces 80 are arranged symmetrically about a center axis AX of the pipe engagement portion 21 shown in FIG. 7. The fastening piece 80 includes a semicircular pipe holding portion 82 that is formed between pipe grasping pieces 81 along the outer diameter of the filler pipe FP. As shown in the sectional views of FIG. 4 and FIG. 8, the pipe holding portion 82 has an inclined surface 82a that is formed on an inner circumferential edge lower surface. Additionally, the fastening piece 80 includes a groove 83 that is provided in a circular plate outer wall to mount and guide the resilient member 90, and a projection 84 that is provided on a plate upper face and is placed in the fastening piece insertion recess 22b of the pipe engagement portion 21 to provide a positioning function in the radial direction. The two fastening pieces 80 of this configuration are inserted from the respective sides into the fastening piece insertion holes 22a of the pipe engagement portion 21 as shown in FIG. 3 to be slidable in the fastening piece insertion holes 22a.

The filler neck 10 is fastened to the filler pipe FP by the fastening structure 70 including the fastening pieces 80 and the resilient member 90 as described below. The two fastening pieces 80 are inserted from the respective sides into the fastening piece insertion holes 22a of the pipe engagement portion 21 and are pressed by the resilient member 90 such that the leading ends of the respective pipe grasping pieces 81 face each other. This state is shown in FIG. 5. The two fastening pieces 80 pressed by the resilient member 90 are arranged such that the respective pipe grasping pieces 81 are located above the flange PF of the filler pipe FP. This completes tentative mounting of the fastening pieces 80. FIG. 5 illustrates the filler pipe FP along with the fastening pieces 80, in order to show the positional relationship between the fastening pieces 80 and the flange PF. The fastening pieces 80 may, however, be inserted into the fastening piece insertion holes 22a prior to insertion of the filler pipe FP.

The filler pipe FP is subsequently inserted into the pipe insertion hole 24 of the pipe engagement portion 21 of the filler neck 10. This causes the flange PF to come into contact with the inclined surfaces 82a of the pipe holding portions 82 of the fastening pieces 80 in the filler neck 10, as shown in FIG. 8. The filler pipe FP is further inserted from this state to cause the fastening pieces 80 to be slid by the flange PF as shown by open arrows in FIG. 8. This retreats the fastening pieces 80 toward the outer circumferential side. When the flange PF rides over the pipe holding portions 82, the pipe opening end PT of the filler pipe FP enters the opening end insertion recess 29 of the pipe engagement portion 21 and the flange PF of the filler pipe FP retains in the flange retention hole 25. When the filler pipe FP is inserted to this state, the force applied from the flange PF to the fastening pieces 80 is eliminated. The fastening pieces 80 accordingly receive the resilient force of the resilient member 90 and cause the respective pipe holding portions 82 to surround the filler pipe FP such that the leading ends of the respective pipe grasping pieces 81 face each other as shown in a lower drawing of FIG. 9. In this state, resilient member end portions 91 of the resilient member 90 are engaged with the engagement projections 23 of the pipe engagement portion 21.

As shown in FIG. 4 and the lower drawing of FIG. 9, the filler pipe FP is surrounded by the pipe holding portions 82 at a position below the flange PF of the filler pipe FP. Accordingly, in the state that the pipe opening end PT is inserted in the opening end insertion recess 29, the filler pipe FP is surrounded by the pipe insertion hole portion 26 of the pipe engagement portion 21 and the flange PF is supported in the flange retention hole 25 by the fastening pieces 80. Accompanied with mounting of the fastening pieces 80 described above, the projections 84 of the fastening pieces 80 are inserted in the fastening piece insertion recesses 22b of the pipe engagement portion 21 to provide the positioning function. The filler neck 10 is accordingly fastened to the filler pipe FP at the pipe engagement portion 21. This completes fastening by the fastening structure 70.

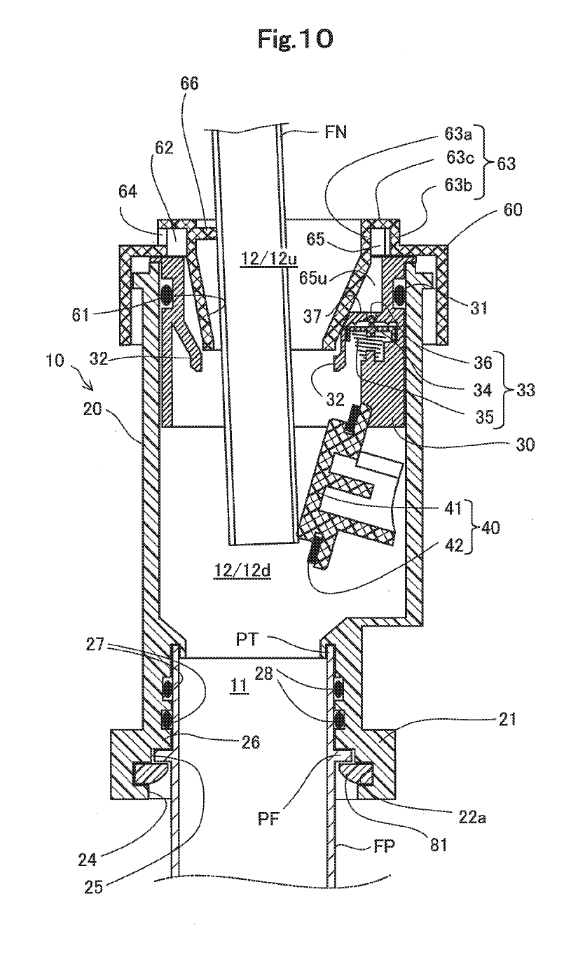

FIG. 10 is a diagram illustrating the fueling nozzle FN at the time of completion of insertion, in relation to the behavior of the lower end open-close mechanism 40. During fueling using the fueling device FS of this embodiment, the fueling nozzle FN is guided by the nozzle guide projection 66 of the insertion flow path portion forming member 60 to be inserted into the upstream-side flow path portion 12u, such that the leading end of the fueling nozzle FN is pressed against the open-close member 41 of the lower end open-close mechanism 40. The fueling nozzle FN is further inserted to press and rotate the open-close member 41 and reach the'downstream-side flow path portion 12d as shown in FIG. 10. After such insertion of the fueling nozzle FN, the fuel is discharged from the fueling nozzle FN, is flowed through the filler pipe FP fastened to the filler neck 10 at the pipe engagement portion 21 by the fastening structure 70, and is introduced into the fuel tank FT (shown in FIG. 1).

In the fueling device FS of the embodiment described above, an external force by insertion of the fueling nozzle FN is applied to the opening end insertion recess 29 of the filler neck 10 that is engaged with the pipe opening end PT of the filler pipe FP. This opening end insertion recess 29 is arranged to continuously cover the flow path inner circumferential wall 11i, the flow path outer circumferential wall 110 and the peripheral wall 11t of the fuel flow path 11 at the pipe opening end PT around the fuel flow path 11. The opening end insertion recess 29 accordingly receives the external force by insertion of the fueling nozzle FN, so as to reduce the external force applied to the fuel flow path 11 on the downstream side of the opening end insertion recess 29 and reduce the possibility of excessive concentration of the external force on the downstream side of the opening end insertion recess 29. Accordingly only a small external force is applied to the pipe insertion hole portion 26 of the pipe engagement portion 21 that is provided from the opening end insertion recess 29 to the downstream side of the fuel flow path 11 to cover the pipe outer circumferential wall of the filler pipe FP and to the fastening structure 70 mounted to the filler pipe FP to fasten this pipe engagement portion 21 to the filler pipe FP. As a result, the configuration of the fueling device FS of this embodiment suppresses fastening of the fastening structure 70 from being loosened by application of an external force and enhances the effectiveness of preventing the filler neck 10 from being unintentionally detached from the filler pipe FP.

In the fueling device FS of the embodiment, the opening end insertion recess 29 is formed on the inner inclined wall from the neck main body 20 to the pipe engagement portion 21. This configuration does not interfere with the flow of the fuel in the nozzle insertion flow path portion 12 of the neck main body 20 or more specifically the flow of the fuel from the downstream-side flow path portion 12d to the fuel flow path 11 of the filler pipe FP. The configuration that the opening end insertion recess 29 is arranged to continuously cover the flow path outer circumferential wall 11o at the pipe opening end PT around the fuel flow path 11 and that the seal members 28 are used in combination enhances the effectiveness of preventing leakage of the fuel from the connecting portion of the resin filler neck 10 with the filler pipe FP.

In the fueling device FS of the embodiment, the resilient member 90 that generates the resilient force is engaged with the two fastening pieces 80 of the fastening structure 70, so that the resilient force of the, resilient member 90 is applied to the fastening pieces 80 as a force of maintaining the state that the fastening pieces 80 are in contact with the flange PF of the filler pipe FP. Additionally, this resilient member 90 is configured to be detachably mounted to the fastening pieces 80. In the fueling device FS of the embodiment, the resilient force applied to the fastening pieces 80 is eliminated by simply detaching the resilient member 90 from the fastening pieces 80. This enables the fastening pieces 80 to move outward from the filler pipe FP and allows for detachment of the filler neck 10 from the filler pipe FP. Furthermore, the fastening pieces 80 are located on the downstream side of the opening end insertion recess 29 in the fuel flow path 11. This configuration reduces the external force applied to the resilient force 90 mounted to the fastening pieces 80. As a result, the configuration of the fueling device FS of the embodiment reduces the possibility that the resilient member 90 mounted to the fastening pieces 80 is unintentionally detached from the fastening pieces 80 by an external force by insertion of the fueling nozzle FN.

In the fueling device FS of the embodiment, the fastening pieces 80 are tentatively mounted prior to insertion of the filler pipe FP. The filler pipe FP is then inserted into the pipe insertion hole 24 of the filler neck 10, so that the filler neck 10 is fastened to the filler pipe FP by the fastening pieces 80 that move outward. The configuration of the fueling device FS of this embodiment accordingly simplifies mounting of the filler pipe FP to the filler neck 10.

The present disclosure is not limited to any of the embodiment, the examples and the modifications described above but may be implemented by a diversity of other configurations without departing from the scope of the disclosure. For example, the technical features of any of the embodiment, the examples and the modifications corresponding to the technical features of each of the aspects described in SUMMARY may be replaced or combined appropriately, in order to solve part or all of the problems described above or in order to achieve part or all of the advantageous effects described above. Any of the technical features may be omitted appropriately unless the technical feature is described as essential herein.

In the embodiment described above, the resilient force of the resilient member 90 is applied to the fastening pieces 80, as the force of holding the fastening pieces 80 at the positions on the outer circumference of the filler pipe FP. According to a modification, the fastening pieces 80 may be constrained from the outer circumferential side of the pipe engagement portion 21 by using a belt or the like.

In the embodiment described above, the opening end insertion recess 29 is arranged to continuously cover the flow path inner circumferential wall 11i, the flow path outer circumferential wall 110 and the peripheral wall 11t of the fuel flow path 11 at the pipe opening end PT around the fuel flow path 11. According to a modification, the flow path inner circumferential wall 11i, the flow path outer circumferential wall 11o and the peripheral wall 11t of the fuel flow path 11 may be covered around the fuel flow path 11 in a region expected to receive a force by insertion of the fueling nozzle-FN.

In the embodiment described above, no other open-close valve mechanism is mounted to the insertion flow path portion forming member 60. According to a modification, another open-close valve mechanism, for example, a flap valve-type open-close valve mechanism that is press-opened by the fueling nozzle FN or a slide valve-type open-close valve mechanism that is slid to be opened and closed by the fueling nozzle FN may be mounted to cover the insertion flow path portion forming member 60.

What is claimed is:

1. A fueling device configured to introduce a fuel supplied from a fueling nozzle to a fuel tank, the fueling device comprising:
a filler pipe configured to form a fuel flow path that is extended to the fuel tank; and
a flow path-forming member configured to form an insertion flow path portion in which the fueling nozzle is inserted, such that the insertion flow path portion communicates with the fuel flow path at a pipe opening end of the filler pipe, wherein
the flow path-forming member comprises:
an opening end engagement portion that is arranged to cover a flow path inner circumferential wall, a flow path outer circumferential wall and a peripheral wall of the fuel flow path at the pipe opening end around the fuel flow path and that is engaged with the filler pipe at the pipe opening end;
an outer circumference covering portion that is provided from the opening end engagement portion to a downstream side of the fuel flow path and that is arranged to cover a pipe outer circumferential wall of the filler pipe; and
a fastening structure that is provided on the outer circumference covering portion and that is configured to fasten the outer circumference covering portion to the filler pipe.

2. The fueling device according to claim 1,
wherein the fastening structure includes a fastening piece that is configured to maintain a coupling state of the outer circumference covering portion and the filler pipe, and a resilient member that is configured to apply a resilient force generated by deformation to the fastening piece, wherein
the resilient member is mounted such that the resilient force of the resilient member is applied to hold the fastening piece at such a position that maintains the coupling state of the outer circumference covering portion and the filler port.

3. The fueling device according to claim 2,
wherein the filler pipe includes a flange that is protruded outward at a position away from the pipe opening end by a predetermined dimension,
the outer circumference covering portion is configured to form a fastening piece insertion hole in which the fastening piece is fit in, wherein the fastening piece insertion hole is formed at a position where the flange is in contact with the fastening piece insertion hole at the pipe opening end of the filler pipe that is engaged with the opening end engagement portion, and
the fastening piece is maintained by the resilient member to be placed on an opposite side to the pipe opening end across the flange in the fastening piece insertion hole.

4. The fueling device according to claim 3,
wherein a portion of the flow path-forming member that is fastened to the filler pipe is formed to have a diameter that is larger than an outer diameter of the filler pipe,
an inclined wall is formed inside of the flow path-forming member from an outer circumference of the flow path-forming member to an innermost circumference position of the outer circumference covering portion, and
the opening end engagement portion formed as a ring-shaped recess in which the pipe opening end of the filler pipe is fit in, at an insertion-side position of the filler pipe corresponding to the inclined wall

5. The fueling device according to claim 4,
wherein the fastening piece insertion hole is provided at two positions on the outer circumference covering portion to be opposed to each other across the fuel flow path,
two fastening pieces are provided corresponding to the fastening piece insertion holes provided at the two positions, are formed in a shape insertable into the respective fastening piece insertion holes, and are configured to be held by the resilient member when the filler pipe is not inserted into the outer circumference covering portion of the flow path-forming member, and
each of the fastening pieces has an inclined surface that is provided on an opposite side to the pipe opening end and is formed in such a shape that an inner side is nearer to the pipe opening end than an outer side.

6. The fueling device according to claim 5,
wherein each of the fastening pieces includes a pipe holding portion that is in contact with the flange, and a projection that is not in contact with the flange, and
the outer circumference covering portion includes a fastening piece insertion recess in which the projection is fit in for positioning.

7. The fueling device according to claim 2,
wherein a portion of the flow path-forming member that is fastened to the filler pipe is formed to have a diameter that is larger than an outer diameter of the filler pipe,
an inclined wall is formed inside of the flow path-forming member from an outer circumference of the flow path-forming member to an innermost circumference position of the outer circumference covering portion, and
the opening end engagement portion is formed as a ring-shaped recess in which the pipe opening end of the filler pipe is fit in, at an insertion-side position of the filler pipe corresponding to the inclined wall.

8. The fueling device according to claim 3,
wherein the fastening piece includes a pipe holding portion that is in act with the flange, and a projection that is not in contact with the flange, and
the outer circumference covering portion includes a fastening piece insertion recess in which the projection is fit in for positioning.
